(19) United States
(12) Patent Application Publication
(10) Pub. No.: US 2005/0079022 A1
(43) Pub. Date: Apr. 14, 2005

(54) Pillar drilling machine

(75) Inventors: Peter Dallinger, Aschheim (DE); Dieter Frey, Heubach (DE)

Correspondence Address: MICHAEL BEST & FRIEDRICH, LLP, 100 E WISCONSIN AVENUE, MILWAUKEE, WI, 53202, US

(73) Assignee: Rotwerk Elektowerkzeuge Und Handelsmarketing Beteiligungsgesellschaft MbH, Aschheim (DE)

(21) Appl. No.: 10/840,054

(22) Filed: May 6, 2004

(30) Foreign Application Priority Data
Oct. 8, 2003 (DE) 203 15 446.0

(51) Int. Cl. B23B 47/00

(52) U.S. Cl. 408/234

(57) ABSTRACT

The present invention relates to a pillar drilling machine comprising a drill head, which is supported on a pillar, and a base for supporting said pillar, as well as a power supply strand leading to said drill head. In order to lead the power supply strand to the drill head as safely as possible and with little risk and hindrance and in order to guarantee simultaneously a good functionality and good handling properties, an accommodation chamber is provided, which extends substantially longitudinally in the interior of said pillar, said power supply strand being arranged, at least sectionwise, in said accommodation chamber such that it extends substantially longitudinally.

The present invention relates to a pillar drilling machine in which a drill head is supported on a pillar and the pillar is, in turn, secured to a base.

Pillar drilling machines are known in which a power supply strand is led out of a drill head. When such a pillar drilling machine is placed e.g. in a corner, the power supply strand hanging down from the drill head will not normally disturb. When the pillar drilling machine is, however, free-standing, the power supply strand hanging down from the drill head may represent a source of accidents as well as an obstacle and, in addition, there is the risk that damage may be caused thereto. Power supply strands which are secured to the outer surface of a pillar are less prone to cause an accident, but the risk of damage still exists. AT 81119 discloses a bench drilling machine in the case of which a power supply strand enters the machine in the area of a cranked support arm.

It is the object of the present invention to improve a pillar drilling machine in such a way that a power supply strand is led to a drill head as safely as possible and with little risk and hindrance and that a good functionality and good handling properties are guaranteed simultaneously.

According to the present invention, this object is achieved by a pillar drilling machine having the features of claim 1.

Due to the fact that the power supply strand extends substantially longitudinally in the interior of the pillar, the power supply strand is arranged such that it is protected against damage as well as such that there is little risk of danger and accidents. The space occupied by the pillar is utilized for accommodating the power supply strand. The pillar itself serves as a protection against danger, hindrance and damage in the area of the accommodation chamber.

Preferably, the power supply strand can extend from the base to the drill head in the interior of the pillar drilling machine. This has the effect that the power supply strand is arranged in a protected and space-saving manner in the whole area of the pillar drilling machine.

According to an advantageous embodiment, a connectable separation point of the power supply strand can be provided in the area of the base and the pillar and/or in the area of the pillar and the drill head. This allows the power supply strand to be separated and connected in this area, whereby mounting and demounting of the respective components will be facilitated.

According to a particularly advantageous embodiment, the separation point can be implemented as a releasable plug connection. In this way, the power supply strand can easily and repeatedly be connected and separated, which will facilitate mounting and demounting.

Preferably, the plug connection can, at least sectionwise, be provided in the interior of the pillar. In this way, the plug connection is arranged in the pillar drilling machine in a protected and space-saving manner.

According to a particularly advantageous embodiment, the plug connection can comprise at least one connector, which is prevented from moving in a direction opposite to the release direction of the plug connection by a tension relief relative to the pillar and/or the base and/or the drill head. This has the effect that, when the plug connection is being released, the connector is substantially held at its position relative to the component or the components in question, whereby a part of the power supply strand attached to the connector is tension relieved when the plug connection is being released.

According to a specially preferred embodiment, the tension relief of a first connector relative to the pillar can be a clamping profile provided on said first connector and/or said pillar. By means of said clamping profile, the first connector is prevented from sliding relative to the pillar when the plug connection is being released. This has the effect that the part of the power supply strand connected to said first connector will be tension relieved when the plug connection is being released.

It will be particularly advantageous when the tension relief of a second connector relative to the base or the drill head is a separate flange member that holds the second connector on said base or said drill head in a direction opposite to the release direction of the plug connection. This has the effect that the part of the power supply strand connected to the second component will be tension relieved when the plug connection is being released.

According to another embodiment of the present invention, the plug connection can comprise at least one connector having at least one locating projection by means of which it is attached to the pillar or the base or the drill head in an oriented manner. The connector is in this way positively retained at a predetermined position relative to the respective component.

According to a particularly preferred embodiment, the plug connection can comprise at least one plug comprising a fastening module and, separately therefrom, an electric connector module which is adapted to be releasably attached to said fastening module. In this way, the fastening function and the electric connecting function of the connector are separated and the respective modules can be replaced. Furthermore, the fastening module can be placed at the intended position on the pillar drilling machine before the connector module is attached thereto.

According to an advantageous embodiment, a storage facility for the power supply strand can be provided in the area of the base. This storage facility can be used for storing at least part of a non-used length of the power supply strand leading away from the pillar drilling machine.

It will be advantageous to implement the storage facility in the form of a cable spider or a cable drum. This cable spider or cable drum can be used for winding thereon at least part of a portion of the power supply strand leading away from the pillar drilling machine.

According to a further embodiment of the present invention, the base can have provided therein at least one opening through which the power supply strand extends from the area of the base to the outside. Making use of this opening, the power supply strand is led in a damage-proof manner out of the area of the base at a defined location.

Preferably, said opening can be provided with a holding element which is adapted to be inserted in said opening and which includes at least one holding profile by means of which the power supply strand can be fixed at a predetermined position relative to said holding element. In this way, the power supply strand is held at a desired position relative to the opening in the base, when said power supply strand is fixed in the holding element and when said holding element has been inserted in said opening.

According to a preferred embodiment, a flange member can be provided by means of which the pillar is supported on the base such that it is centered relative thereto. By means of said flange member, reference areas of the pillar and of the base are held at a predetermined position relative to one another.

According to a preferred embodiment of the present invention, a plug connection can be arranged, at least sectionwise, in the interior of the flange member. The plug connection is thus located in an area in which the pillar and the base are separable from and connectable to one another. The separation and the connection of the power supply strand takes place simultaneously with the separation and the connection of the pillar and the base.

According to a particularly advantageous embodiment, the pillar and the flange member can each include at least one hole through which one and the same fixing means extends at least sectionwise. In this way, the pillar and the flange member can be secured at a predetermined position relative to on another.

According to a further embodiment of the present invention, the drill head can be adapted to be rotated relative to the pillar and a rotation limiting device can be provided. This prevents excessive rotation of the drill head relative to the pillar. A power supply strand extending between the pillar and the drill head is thus protected against excessive stress.

According to a particularly advantageous embodiment, a recess can be provided on the pillar or the drill head and a profile, which is adapted to be guided in said recess, can be provided on said drill head or said pillar, the rotational movement being limited in that the profile comes into contact with the end portions of said recess. In this way, the rotation limiting means is defined by the dimensions of said recess and the dimensions of the profile that is adapted to be guided in said recess.

Preferably, the recess can be implemented as a groove extending transversely to the longitudinal direction of the pillar. The groove limits the relative movability of the pillar and the drill head in the longitudinal direction of the pillar. This will also have the effect that the drill head on the pillar is protected against unintentional removal.

According to a preferred embodiment, a releasable clamping means can be supported between the pillar and the drill head; by means of said releasable clamping means the drill head can be prevented from rotating relative to the pillar. Said clamping means can be used for fixing certain relative positions of the pillar and of the drill head.

According to an advantageous embodiment, said clamping means can comprise two clamping elements which are of such a nature that the distance between them can be adjusted and each of which is adapted to be brought into clamping engagement with the pillar, said clamping means being radially supported relative to the drill head. By varying the distance between said clamping elements, a frictional force produced between said clamping elements and said pillar can be adjusted. The application of the frictional force is guaranteed in that the clamping means maintains its radial position relative to the pillar.

According to a particularly advantageous embodiment, the clamping means can be provided with a screw mechanism by means of which the distance between the clamping elements can be adjusted. The screw mechanism represents a transmission by means of which a fine adjustment of the distance between the clamping elements can be carried out and by means of which a strong clamping force preventing the drill head from being rotated relative to the pillar can be produced by a small operating force.

It will be advantageous when at least one of said clamping elements has a contact surface corresponding to the shape of the pillar. This contact surface can be used for pressing the clamping element onto the pillar in a manner that is adapted to the pillar in question.

According to an advantageous embodiment, the clamping means can be accommodated in a hollow space of the drill head, which is intersected by a connection piece that accommodates the pillar sectionwise. In the intersecting area, the clamping means is in contact with the pillar and can act on said pillar such that a holding effect is produced.

Embodiments of the present invention are shown in the drawing, in which:

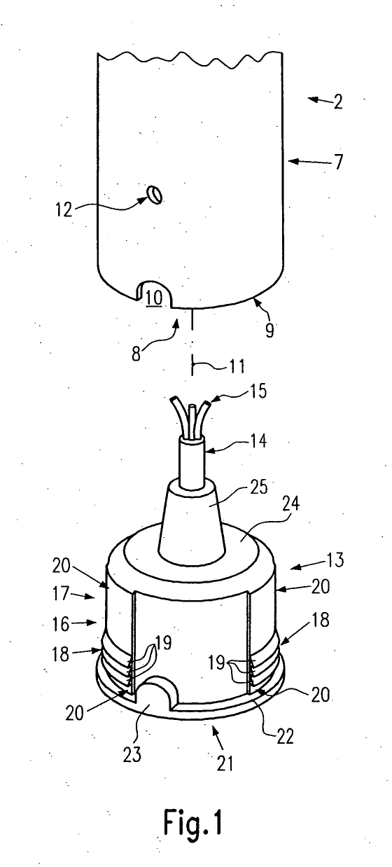

FIG. 1 shows a perspective exploded view of a first connector of a plug connection and an area of a pillar of a first embodiment of a pillar drilling machine according to the present invention,

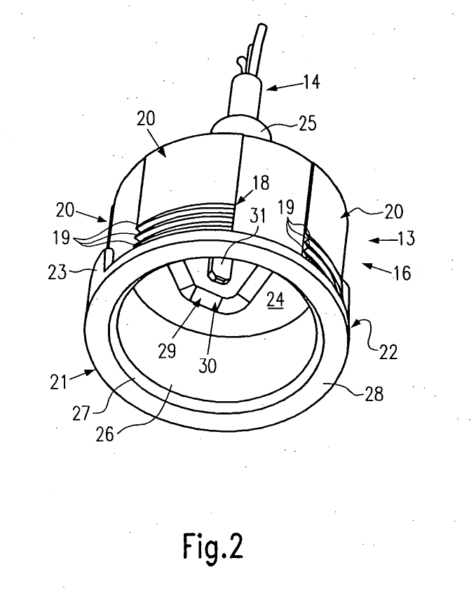

FIG. 2 shows a perspective view of the first connector of the plug connection,

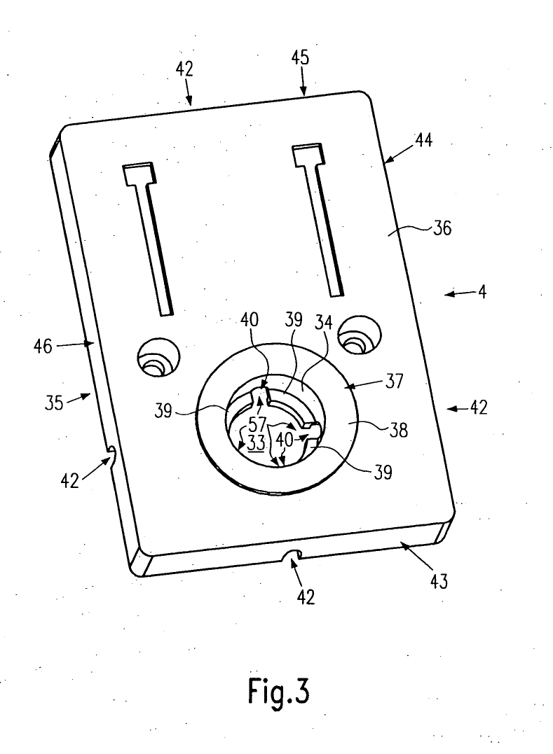

FIG. 3 shows a perspective view of a base of the pillar drilling machine,

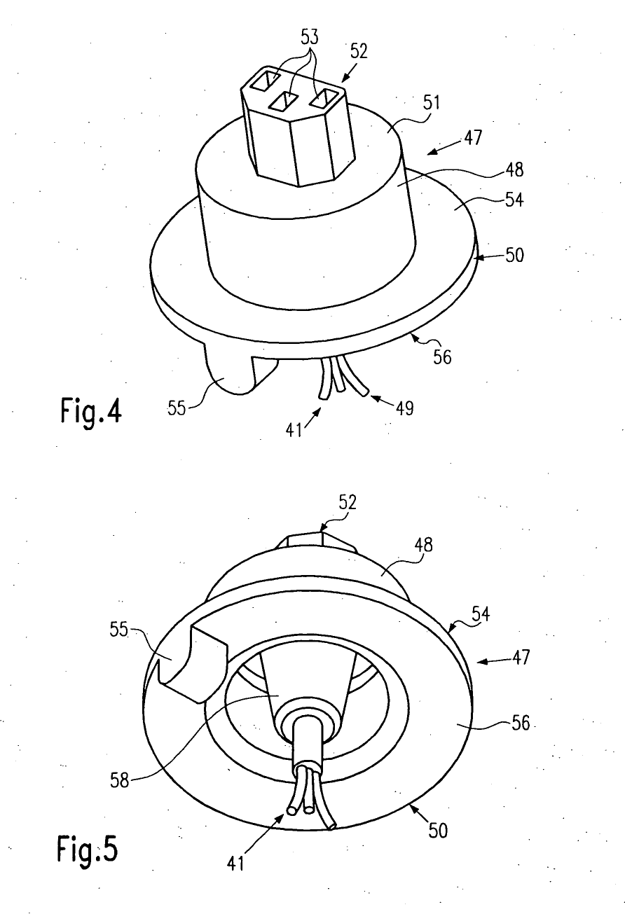

FIG. 4 shows a perspective view of a second connector of the plug connection of the pillar drilling machine,

FIG. 5 shows a further perspective view of said second connector,

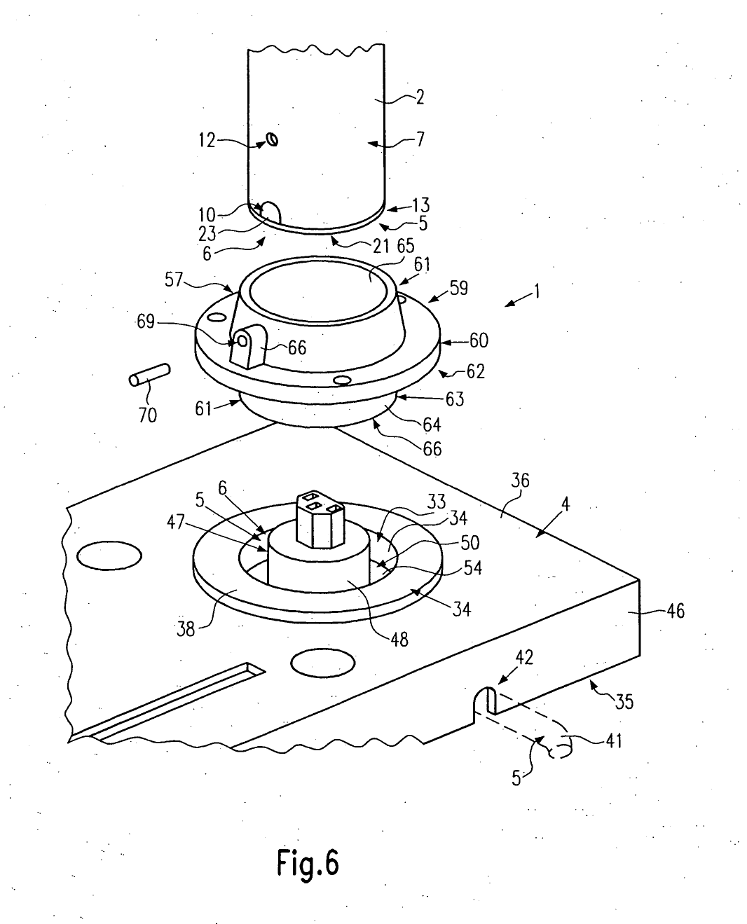

FIG. 6 shows a sectionwise, perspective, partially exploded view of a connection area between the pillar and the base of the pillar drilling machine,

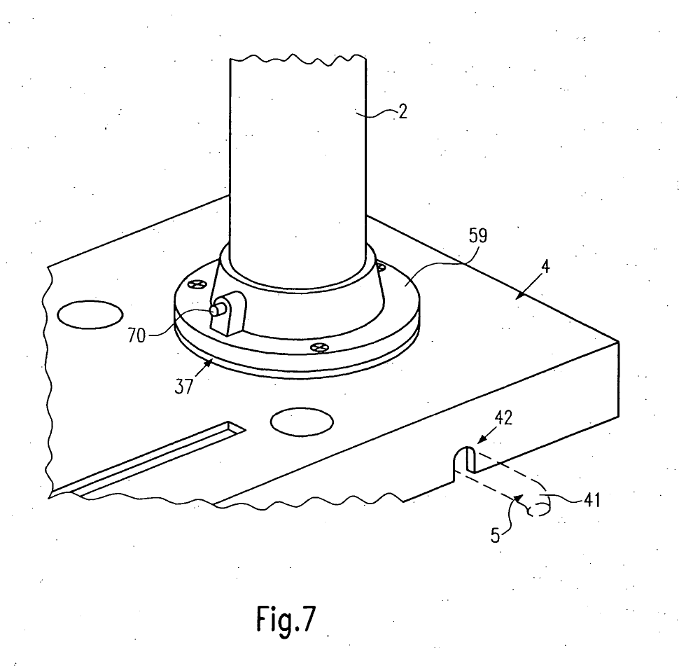

FIG. 7 shows a sectionwise, perspective view of the pillar and of the base in the mounted condition,

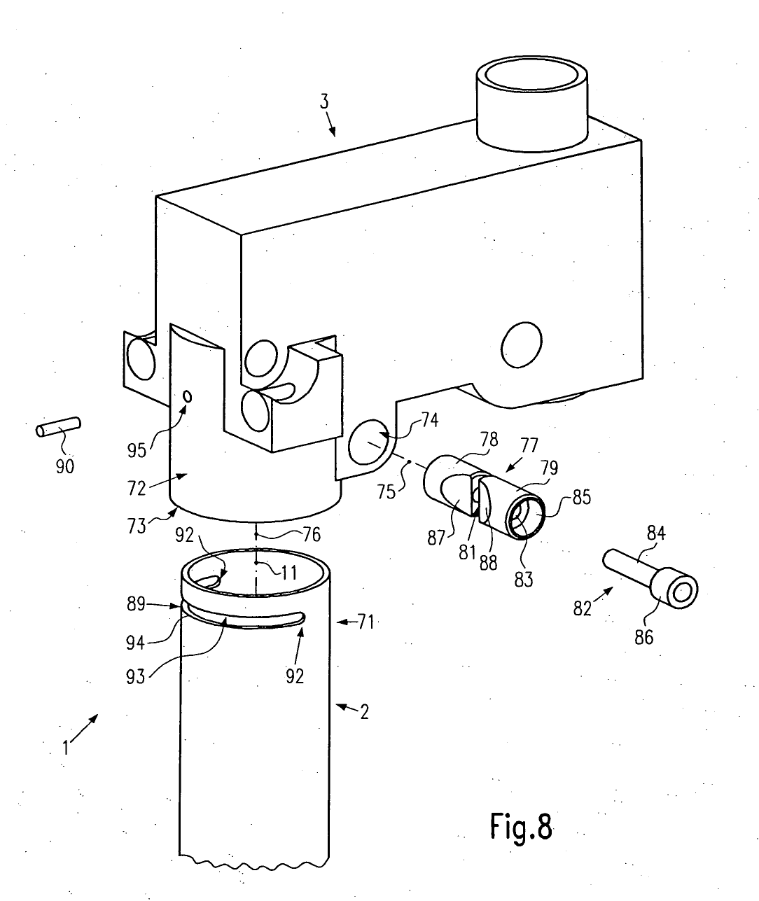

FIG. 8 shows a perspective exploded view of a drill head, a clamping means, a rotary angle limiting device and an area of the pillar of the pillar drilling machine,

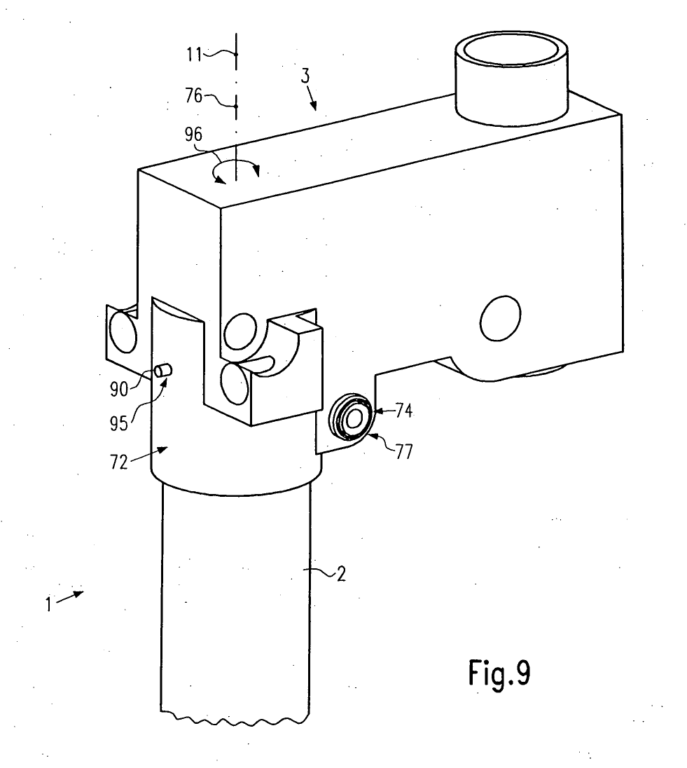

FIG. 9 shows a perspective view of the components shown in FIG. 8, in a mounted condition,

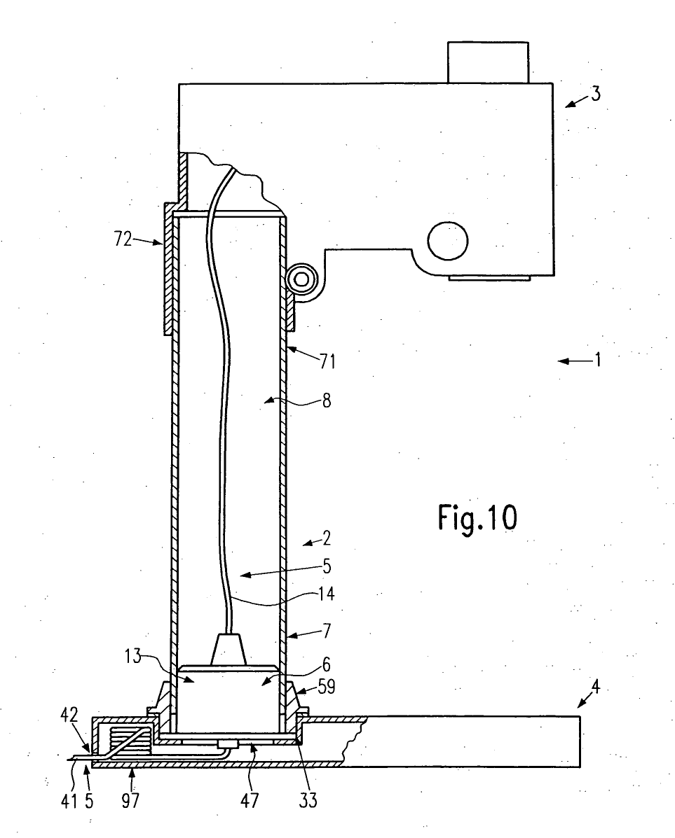

FIG. 10 shows a schematic representation of the pillar drilling machine, part of said representation being a sectional view,

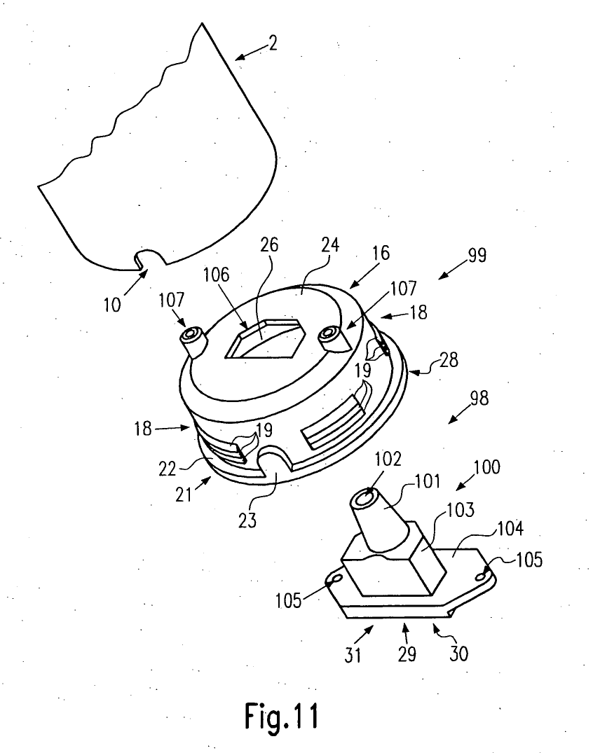

FIG. 11 shows an alternative embodiment of a first connector of the pillar drilling machine according to the present invention and

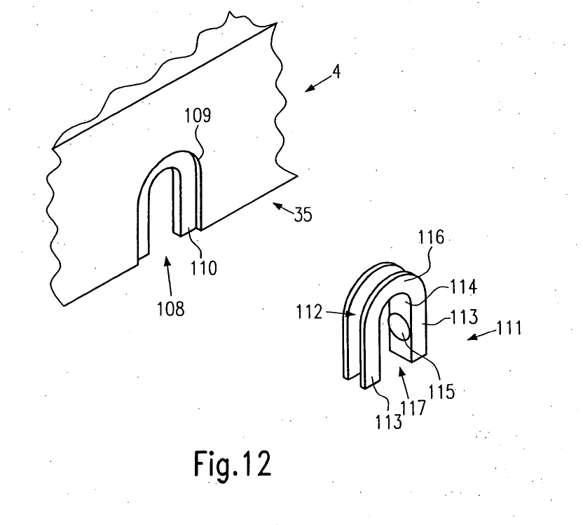

FIG. 12 shows an alternative embodiment of an opening in the base of the pillar drilling machine according to the present invention.

A pillar drilling machine 1 comprises a drill head 3 supported on a pillar 2, and a base 4 on which the pillar 2 is mounted. The pillar 2 is provided with an accommodation chamber 8 extending substantially longitudinally in the interior thereof. A power supply strand 5 of the pillar drilling machine 1 extends over the entire length of the pillar 2 substantially longitudinally in said accommodation chamber 8. In this embodiment of the present invention the power supply strand enters the base 4 and extends in the interior of the pillar 2 up to the drill head 3, cf. FIG. 10.

The power supply strand 5 is provided with a connectable separation point which is implemented as a releasable plug connection 6. In this embodiment, the plug connection 6 is provided in the area in which the pillar 2 is mounted on the base 4. In accordance with a further development of the invention, the plug connection can, alternatively or additionally, be provided in an area in which the drill head 3 is mounted on the pillar 2.

In FIG. 1, the pillar 2 is shown sectionwise with a base-side end 7. The pillar 2 has a substantially elongate and hollow-cylindrical structural design. The hollow-cylindrical interior of the pillar 2 defines the accommodation chamber 8 in the interior of which the power supply strand 5 extends.

In the area of an end face 9 of the base-side end 7, the pillar 2 has a substantially U-shaped opening 10 which opens towards said end face 9. Parallel to a central axis 11 of the pillar 2, a radially extending pin hole 12 is provided in spaced relationship with the opening 10.

According to another embodiment of the present invention, a recess can be formed, alternatively or additionally, on a drill head-side end of the pillar.

The plug connection 6 is provided with a first connector 13 which is adapted to be inserted sectionwise into the accommodation chamber 8 of the pillar 2. The first connector 13 has connected thereto a first cable section 14 belonging to the power supply strand 5 and leading to the drill head 3. In FIG. 1, a piece of the first cable section 14 with individual conductors 15 is outlined.

The first connector 13 comprises a substantially hollow-cylindrical portion 16 provided with clamping profiles 18 on the outer surface thereof. Each of said clamping profiles 18 comprises several, in the present case three, circumferential ribs 19 projecting radially outwards. The respective circumferential ribs 19 extend over a portion of the circumference of the hollow-cylindrical portion 16. In the circumferential area of the clamping profiles 18, the material of the hollow-cylindrical portion 16 is reinforced and/or stiffened; this is indicated by reference numeral 20.

Opposite to the outgoing first cable section 14, a engagement flange 21, which extends radially outwards, is formed on the hollow-cylindrical portion 16. The engagement flange 21 is provided with a pillar-side contact surface 22 with which it can be brought into contact with the end face 9 of the pillar 2. A first locating projection 23, which extends from the engagement flange 21, is formed on the hollow-cylindrical portion 16, the outer contour of said locating projection 23 corresponding to the shape of the opening 10 in the pillar 2.

On the side of the first cable section 14, a plate area 24 is arranged, which extends radially inwards and on which a male connector 25 is formed. The male connector 25 has frusto-conically shaped contours and it holds part of the first cable section 14.

The perspective representation according to FIG. 2 clearly shows the interior and the lower side of the first connector 13. The hollow-cylindrical portion 16 has a cylindrical inner wall 26 which is followed by a chamfer 27 in the area of the engagement flange 21. The engagement flange 21 is provided with an end contact surface 28 located opposite the pillar-side contact surface 22.

The interior of the male connector 25, implemented as a male connector reception means 29, extends from the plate area 24, said male connector reception means 29 being provided with a recess 30 in which male contacts 31 are arranged. The representation according to FIG. 2 shows, however, only one male contact 31. A chamfer 32 is formed as a transition from the recess 30 to the plate area 24.

Alternatively, a female connector, instead of the male connector 25, can be provided in the case of the first connector 13.

When the first connector 13 is inserted into the accommodation chamber 8 of the pillar 2, the first locating projection 23 is received in the opening 10 of the pillar 2 in positive engagement therewith. This has the effect that the first connector 13 will be oriented at a predetermined position relative to the pillar 2.

Furthermore, the clamping profiles 18 are in contact with the inner surface of the accommodation chamber 8, the outer diameter of the first connector 13, which is defined by said clamping profiles, being slightly larger than the inner diameter of the accommodation chamber 8. This has the effect that the clamping profiles 18 abut under pressure on the inner surface of the pillar 2, the circumferential ribs being slightly deformed. Due to this pressure and the rib-shaped configuration of the clamping profiles 18, the first connector 13 is secured to the pillar 2 such that it is prevented from moving in a direction opposite to the release direction of the plug connection 6. It follows that that the clamping profiles 18 embody a tension relief of the first connector 13 relative to the pillar 2. Due to this tension relief, the first cable section 14 will remain in a tension-relieved condition when the plug connection 6 is released.

In FIG. 6, the first connector 13 is shown in a condition in which it is mounted on the pillar 2.

In FIG. 3, the base 4 is clearly shown. The base 4 is provided with a reception opening 33 comprising a cylindrical portion 34 whose longitudinal direction extends approximately at right angles to a support surface 35 of the base 4. A base flange 37 is implemented such that it extends circularly around the reception opening 33, said base flange 37 having a base flange contact surface 38 which extends substantially parallel to the support surface 35. The base flange 37 projects beyond an upper surface 36 of the base 4.

The reception opening 33 is provided with a plurality of retaining projections 39 which extend radially inwards from the cylindrical portion 34 and which have the shape of circular ring sectors. Gaps 57 in the area of which the cylindrical portion 34 is provided with cable ports 40 are provided between the retaining projections 39, said cable ports 40 being implemented such that they are sectionwise U-shaped and open towards the support surface 35. In addition, the base 4 has four openings 42 each terminating on one of the outer surfaces 43, 44, 45, 46 of said base 4 and having a U-shape that is open towards the support surface 35. A second cable section of the power supply strand 5 can be passed through said openings 42 to the outside of the base 4. The cable ports 40 are adapted to be used for introducing said second cable section 41 into the reception opening 33.

In the area of the base 4, a storage facility for the power supply strand 5 is provided in the form of a cable spider or a cable drum, which is not shown in FIG. 3. The storage facility serves to stow the second cable section 41 when the pillar drilling machine 1 has been disconnected from the mains, or to stow lengths of the second cable section 41 which are not needed.

A second connector 47 of the plug connection 6 is shown in FIG. 5 in a first perspective view. The second connector 47 is implemented such that it corresponds to and is adapted to be attached to the first connector 13. The second connector 47 has connected thereto the second cable section 41 of the power supply strand 5, said second cable section 41 being shown only sectionwise with individual conductors 49 in FIG. 5.

The second connector 47 comprises a cylindrical portion 48 and a contact flange 50 which extends on the sides of the second cable section 41 radially therefrom. The cylindrical portion 48 corresponds to the cylindrical inner wall 26 of the first connector 13 and the contact flange 50 corresponds to the engagement flange 21 of the first connector 13.

Opposite to the contact flange 50 of the second connector 47, the cylindrical portion 48 has formed thereon a plate area 51 which extends radially inwards and which has formed thereon a female connector that corresponds to the male connector reception means 29 of the first connector 13. The female connector 52 extends outwards in the longitudinal direction of the cylindrical portion 48 and substantially at right angles to the plate area 51. The female connector 52 is provided with plug-in openings 53 into which the male contacts 31 of the first connector 13 can be inserted.

Alternatively, a male connector, instead of the female connector 52, can be provided in the case of the second connector 47.

The contact flange 50 of the second connector 47 has an annular contact surface 54 on the side of the cylindrical portion 48. Opposite to said annular contact surface 54, a second locking projection 55 protruding in the axial direction of the cylindrical portion 48 is formed on the contact flange. On the side of the second locking projection 55, the contact flange 50 is provided with a joining surface 56.

The second locking projection 55 fits into the respective gaps 57 between the retaining projections 39 of the base 4. When the second connector 47 is inserted into the reception opening 33, the connector 47 is positioned at a predetermined position relative to the base 4 by means of the second locking projection 55. The joining surface 56 of the contact flange 50 rests sectionwise on the retaining projections 39 of the reception opening 33. The outer diameter of the contact flange 50 is slightly smaller than the diameter of the cylindrical portion 34 of the reception opening 33.

In FIG. 5 the second connector 47 is shown in a perspective view from below. The cylindrical portion 48 of the second connector 47 has a hollow-cylindrical structural design, a frusto-conically shaped cable bearer 58 extending from the plate area 51 into the interior of the cylindrical portion 48. The cable bearer 58 holds a portion of the second cable section 41.

According to one embodiment of the present invention, an analogous second connector, which is adapted to be attached to the drill head 3 in an analogous manner, can be provided alternatively or additionally. The drill head 3 can be provided with a reception opening which is analogous to the reception opening 33 of the base 4.

In FIG. 6, said second connector 47 is shown in a condition in which it is inserted in the reception opening 33 of the base 4. Furthermore, FIG. 6 illustrates in the form of broken lines a part of the second cable section 41 which extends through the opening 42 on the outer surface 46 of the base 4 to the outside of said base 4.

For mounting the pillar 2 to the base 4, a flange member 59 is provided. The flange member 59 comprises a mounting flange 60 and a pillar sleeve 61. The mounting flange 60 has a substantially annular structural design and extends radially outwards from the pillar sleeve 61. A lower surface 62 of the mounting flange 60 is implemented such that it corresponds to the base flange contact surface 38 and is adapted to be secured thereto in substantially positive engagement therewith.

A part of the pillar sleeve 61 that extends below the mounting flange 60 is implemented as a hollow-cylindrical spacer portion 63. The spacer portion 63 has an outer circumferential surface 64 which is concentric with an inner cylindrical surface 65 extending through the whole pillar sleeve 61. The inner cylindrical surface 65 is implemented such that it corresponds to the outer contour of the base-side end 7 of the pillar 2, said base-side end 7 of the pillar 2 being adapted to be inserted in the interior of the flange member 59 formed with said inner cylindrical surface 65.

The outer circumferential surface 64 of the spacer portion 63 is implemented such that it corresponds to the cylindrical portion 34 of the reception opening 33 of the base 4, said spacer portion 63 being adapted to be inserted in the reception opening 33. The lower surface 62 of the mounting flange 60 comes then into contact with the base flange surface 38 of the base 4 and an end face 66 of the spacer portion 63 comes into contact with the contact surface 54 of the contact flange 50 of the second connector 47. In this condition, the flange member 59 is screw-fastened to the base 4.

Following this, the base-side end 7 of the pillar 2 is introduced in the interior of the pillar sleeve 61, which means that the first and the second connectors 13, 47 of the plug connection 6 are simultaneously attached to one another. The pillar 2 is inserted into the pillar sleeve 61 to such an extent that the engagement flange 21 of the first connector 13 comes into contact with the contact flange 50 of the second connector 47.

In the condition in which the pillar is mounted on the base 4, the flange member 59 holds the second connector 47 such that it is prevented from moving in a direction opposite to the release direction of the plug connection 6. It follows that that the flange member 59 embodies a tension relief of the second connector 47 relative to the base 4; due to this tension relief, the second cable section 41 will remain in a tension-relieved condition when the plug connection 6 is released.

On an upper section 57 of the pillar sleeve 61, a pin reinforcement 68 is provided in the area of the mounting flange, said pin reinforcement 68 extending radially outwards and being provided with a pin hole 69. When the pillar 2 has been inserted in the flange member 59 and, consequently, in the reception opening 33 of the base 4, a pin 70 is passed through the pin hole 69 of the flange member 59 up to and into the pin hole 12 of the pillar 2, whereby said pillar 2 will be secured in position relative to the flange member 59.

By means of the flange member 59, the pillar 2 is supported on the base 4 such that it is centered thereon and in positive engagement therewith, the plug connection 6 being arranged sectionwise in the interior of the flange member 59. FIG. 7 shows the pillar 2 in the mounted condition.

According to a further development of the present invention, an analogous flange member can be provided, alternatively or additionally, in the area between the pillar and the drill head; this flange member can have functions analogous to those of the flange member 59 provided in the area of the pillar 2 and the base 4.

As can be seen from FIG. 8, the pillar 2 has a drill head-side end 71. The drill head 3 is provided with a connection piece 72 whose cylindrical interior is implemented such that it corresponds to the drill head-side end 71 of the pillar 2, said drill head-side end 71 of pillar 2 being adapted to be inserted into the connection piece 72. On the basis of the cylindrical interior 73 of the connection piece 72 and of the pillar 2, the drill head 3 is adapted to be rotated relative to the pillar 2 about the central axis 11 of said pillar 2.

In the area of the connection piece 72, the drill head 3 is provided with an opening intersecting the interior 73 of the connection piece 72. The central axis 75 of the opening 74 extends substantially transversely to the central axis 76 of the interior 73 of the connection piece 72. A clamping means 77 comprising a first clamping element 78 and a second clamping element 79 is adapted to be positioned in the opening 74. The two clamping elements 78, 79 have, sectionwise, a cylindrical outer surface which corresponds to the opening 74 of the drill head 3.

The first clamping element 78 is provided with a tapped hole 81 into which a screw 82 of the clamping means 77 can be inserted. The second clamping element 79 is provided with a through-hole 83 through which the threaded part 84 of the screw 82 can be passed, and a screw head reception means 85 for receiving the screw head 86 of the screw 82 and for bringing it into contact with the second clamping element 79.

The distance between the two clamping elements 78, 79 can be adjusted with the aid of the screw 82, the tapped hole 81 and the screw 82 being used as a transmission.

The first and the second clamping elements 78, 79 have respective contact surfaces 87, 88 which correspond to the outer contour of the pillar 2. When the pillar 2 has been inserted in the connection piece 72 and when the clamping means 77 is located in the opening 74, the two contact surfaces 87, 88 are each adapted to be brought into clamping contact with the pillar 2 by reducing the distance between said two clamping elements 78, 79. This has the effect that a frictional force is applied between the pillar 2 and the clamping means 77; the tighter the two clamping elements 78, 79 are drawn towards one another, the stronger said frictional force will be. The contact pressure applied in this way between the clamping means 77 and the pillar 2 is taken up by the opening 74 of the drill head 3 in which the clamping means 77 is supported on said drill head 3 radially relative to the pillar 2.

Due to the fact that the clamping means 77 is accommodated in the opening 74, said clamping means 77 is prevented from pivoting about the central axis 76 of the connection piece 72 or the central axis 11 of the pillar 2. In view of the fact that it is accommodated in the opening 74, the clamping means 77 is retained radially relative to the pillar 2. By clamping the releasably supported clamping means 77, the drill head 3 is prevented from rotating relative to the pillar 2.

The clamping means 77 can also be used in machines or devices other than the present pillar drilling machine. The clamping means 77 can be used wherever a component is rotatably supported on a pillar-like element, e.g. a housing component on a round pillar. With the aid of the clamping means 77, the component is releasably fixable at a position relative to the pillar-like element. The use of the clamping means 77 is independent of the nature and the routing of a power supply strand.

In the area of its drill head-side end 71, the pillar 2 is provided with a circumferentially extending recess 89. In said recess 89, a rotation limiting pin 90 can be guided between a first stop end 91 and a second stop end 92 of said recess 89.

The recess 89 is implemented as a groove extending approximately transversely to the longitudinal direction 11 of the pillar 2 and has edges 93, 94 which are spaced-apart at a distance that is only slightly larger than the diameter of the rotation limiting pin 90.

The connection piece 72 of the drill head 3 is provided with a radial pin hole 95 into which the rotation limiting pin 90 can be inserted. When the pillar 2 has been inserted in the connection piece 72, the rotation limiting pin 90 projects into the interior 73 of the connection piece 72 and into the recess 89 of the pillar 2. Due to the shape of the recess 89, the rotation limiting pin 90 limits a respective rotational movement of the drill head 3 relative to the pillar 2 by striking against one of the two stop ends 91, 92. Simultaneously, the rotation limiting pin 90 protects the drill head 3 against unintentional removal from the pillar 2, since a movement of the rotation limiting pin 90 in the longitudinal direction of the central axis 11 of the pillar 2 is blocked by the edges 93, 94 of the recess 89. The rotation limiting pin 90, the pin hole 95 and the recess 89 of the pillar 2 form a rotation limiting device.

FIG. 9 shows the drill head 3 in a condition in which it is mounted on the pillar 2. The rotation limiting pin 90 is inserted in the pin hole 95 and projects thus into the recess 89 of the pillar 2. The clamping means 77 is located in the opening 74 of the drill head 3 in the mounted condition.

Furthermore, the rotatability of the drill head 3 about the central axis 11 of the pillar 2 is indicated by the arrow 96 in FIG. 9. From a starting position at which the drill head 3 and the base 4 are oriented substantially longitudinally to one another with regard to their longitudinal directions on the same side of the pillar 2, the drill head 3 can be rotated by approx. 90° to either side, i.e. the drill head 3 can be rotated by approx. 180°.

FIG. 10 shows a view of the pillar drilling machine 1 according to the present invention, part of said view being a sectional view. In particular, it is clearly shown how the second cable section 41 of the power supply strand 5 enters the base 4 through one of the openings 42 and how a part of the second cable section 41 is stored in a condition in which it is wound on the storage facility 97 which is here implemented like a cable drum. From the storage facility 97 said second cable section 41 leads to the second connector 47 of the plug connection 6. The second connector 47 is attached to the first connector 13, a portion of which is located in the accommodation chamber 8 of the pillar 2. From the first connector 13, the first cable section 14 extends, in a freely suspended manner, through the accommodation chamber 8 into the interior of the drill head 3. In view of this free routing of the power supply strand 5 from the pillar 2 into the drill head 3, the above-mentioned rotation limiting device 90, 95, 89 is provided so as to avoid excessive stress on the power supply strand 5 caused by rotating the drill head 3.

FIG. 11 shows an alternative embodiment of the first connector. Identical elements have identical reference numerals and the same function as in the case of the first connector 13 of the first embodiment of the present invention.

The alternative first connector 98 comprises a fastening module 99 and an electric connector module 100, which is separate from said fastening module 99. The electric connector module 100 is adapted to be releasably attached to the insert 99.

The electric connector module 100 has a frusto-conically shaped portion 101 provided with a hole 102 in which an end portion of the first cable section 14 can be accommodated. The frusto-conically shaped portion 101 is followed by a connector area 103 having a hexagonal outer contour in the case of this embodiment. The connector area 103 is followed by a fastening flange 104 extending radially outwards and having two fastening holes 105. In the area of the fastening flange 104 and in the area of a portion of the connector area 103, the connector module 100 has a recessed portion 30 with male connector reception means 29 and male contacts 31. Deviating from this embodiment, the connector module 100 can also be implemented as a female connector.

Like the first connector 13 of the first embodiment, the fastening module 99 of the alternative first connector 98 is adapted to be introduced at one end of the pillar 2 into the accommodation chamber 8 thereof, to be positioned relative to said pillar 2 and to be tension-relieved with the aid of the clamping profiles 18. The fastening module 99 has in its plate area 24 a hexagonal opening 106 which corresponds to the outer contour of the connector area 103 of the connector module 100.

For mounting the alternative first connector 98, the electric connector module 100, with the frusto-conically shaped portion 101 ahead, is passed into the interior of the fastening module 99 and through the opening 106 thereof, until the fastening flange 104 abuts on the plate area 24 in the interior of the fastening module 99. The connector area 103 is then sectionwise accommodated in the opening 106 in positive engagement therewith.

For fastening the electric connector module 100 to the fastening module 99, screws, which are not shown, are introduced through the fastening holes 105 and screwed into screwreception pieces 107 of the fastening module 99, whereby the connector module 100 is releasably fastened to the fastening module 99.

The fastening module 99 and the electric connector module 100 are each adapted to be standardized, in particular with respect to corresponding areas of the two modules. In this standardized form, various modules can then be combined with one another.

Analogously to the alternative first connector 98, also the second connector of the plug connection 6 can be provided with a fastening module and an electric connector module, which is separate from said fastening module and which is adapted to be releasably attached to the fastening module.

FIG. 12 shows a section of the base 4 having an alternatively implemented opening 108. Like the opening 42 of the first embodiment, the opening 108 is substantially U-shaped and opens towards the support surface 35 of the base 4. The alternative opening 108 has, however, on the inner circumference 109 thereof a U-shaped element 110 which is formed integrally with the base 4. The thickness of the U-shaped element 110 is smaller than the wall thickness of the base 4 in the area of the alternative opening 108.

A substantially U-shaped holding element 111 is adapted to be inserted in the alternative opening 108, said holding element 111 being implemented such that it corresponds to the inner circumference 109 and to the U-shaped element 110 of said alternative opening 108.

The holding element 111 has on the outer circumference thereof an outer groove 112 in which the U-shaped element 110 of the alternative opening 108 is accommodated at least sectionwise, when the holding element 111 has been inserted in said alternative opening 108.

The holding element 111 has, at least in the area of its U-ends 113, a bulge 115 that projects from the U-interior of said holding element 111. In the case of the present embodiment, said bulge 115 has a shape that corresponds approximately to part of a sphere and it serves to hold the second cable section 41 in a condition in which said second cable section is inserted in the U-interior of the holding element 111. Said second cable section 41 is then held, i.e. fixed in the area between the bulge 115 and the U-bow 116 of the holding element 111.

The holding element 111 is preferably produced from an elastic material or an elastomer material, such as rubber.

1. A pillar drilling machine comprising a drill head which is supported on a pillar, and a base for supporting said pillar, as well as a power supply strand leading to said drill head, wherein an accommodation chamber is provided, which extends substantially longitudinally in the interior of said pillar, said power supply strand being arranged, at least sectionwise, in said accommodation chamber such that it extends substantially longitudinally.

2. A pillar drilling machine according to claim 1, wherein the power supply strand extends from the base to the drill head in the interior of the pillar drilling machine.

3. A pillar drilling machine according to claim 1, wherein in the area of the base and the pillar and/or in the area of the pillar and the drill head a respective connectable separation point of the power supply strand is provided.

4. A pillar drilling machine according to claim 3, wherein the separation point is implemented as a releasable plug connection.

5. A pillar drilling machine according to claim 4, wherein the plug connection is, at least sectionwise, provided in the interior of the pillar.

6. A pillar drilling machine according to claim 4, wherein the plug connection comprises at least one connector, which is prevented from moving in a direction opposite to the release direction of the plug connection by a tension relief relative to the pillar and/or the base and/or the drill head.

7. A pillar drilling machine according to claim 6, wherein the tension relief of a first connector relative to the pillar is a clamping profile provided on said first connector and/or said pillar.

8. A pillar drilling machine according to claim 6, wherein the tension relief of a second connector relative to the base or the drill head is a separate flange member that holds the second connector on said base or said drill head in a direction opposite to the release direction of the plug connection.

9. A pillar drilling machine according to claim 4, wherein the plug connection comprises at least one connector having at least one locating projection by means of which it is attached to the pillar or the base or the drill head in an oriented manner.

10. A pillar drilling machine according claim 4, wherein the plug connection comprises at least one plug comprising a fastening module and, separately therefrom, an electric connector module which is adapted to be releasably attached to said fastening module.

11. A pillar drilling machine according to claim 1, wherein a storage facility for the power supply strand is provided in the area of the base.

12. A pillar drilling machine according to claim 11, wherein the storage facility is implemented in the form of a cable spider or a cable drum.

13. A pillar drilling machine according to claim 1, wherein the base has provided therein at least one opening through which the power supply strand is led out of the area of the base.

14. A pillar drilling machine according to claim 13, wherein the opening is provided with a holding element which is adapted to be inserted in said opening and which includes at least one holding profile by means of which the power supply strand can be fixed at a predetermined position relative to said holding element.

15. A pillar drilling machine according to claim 1, wherein a flange member is provided by means of which the pillar is supported on the base such that it is centered relative thereto.

16. A pillar drilling machine according to claim 15, wherein a plug connection is arranged, at least sectionwise, in the interior of the flange member.

17. A pillar drilling machine according to claim 15, wherein the pillar and the flange member each include at least one hole through which one and the same fixing means extends at least sectionwise.

18. A pillar drilling machine according to claim 1, wherein the drill head is adapted to be rotated relative to the pillar and that a rotation limiting device is provided.

19. A pillar drilling machine according to claim 18, wherein a recess is provided on the pillar or the drill head and that a profile, which is adapted to be guided in said recess is provided on said drill head or said pillar, the rotary movement being limited in that the profile comes into contact with the end portions of said recess.

20. A pillar drilling machine according to claim 19, wherein the recess is implemented as a groove extending transversely to the longitudinal direction of the pillar.

21. A pillar drilling machine according to claim 18, wherein between the pillar and the drill head, a releasable clamping means is supported by means of which the drill head can be prevented from rotating relative to the pillar.

22. A pillar drilling machine according to claim 21, wherein the clamping means comprises two clamping elements which are of such a nature that the distance between them can be adjusted and each of which is adapted to be brought into clamping engagement with the polar, said clamping means being radially supported on the drill head.

23. A pillar drilling machine according to claim 22, wherein the clamping means is provided with a screw mechanism by means of which the distance between said clamping elements can be adjusted.

24. A pillar drilling machine according to claim 22, wherein at least one of said clamping elements has a contact surface corresponding to the shape of the pillar.

25. A pillar drilling machine according to claim 21, wherein the clamping means is accommodated in a hollow space of the drill head, which is intersected by a connection piece in which the pillar is accommodated sectionwise.
